(19) United States
(12) Patent Application Publication
(10) Pub. No.: US 2016/0360732 A1
(43) Pub. Date: Dec. 15, 2016

(54) Adjustable Animal Muzzle

(71) Applicant: Jarred Lyons, Valley Village, CA (US)

(72) Inventor: Jarred Lyons, Valley Village, CA (US)

(21) Appl. No.: 15/238,140

(22) Filed: Aug. 16, 2016

(51) Int. Cl. A01K 25/00

(52) U.S. Cl. CPC A01K 25/00

(57) ABSTRACT

An adjustable muzzle for use on an animal. The muzzle includes a muzzle body having a flexible webbing with two strap channels for a semi-flexible strap. The strap is threaded within the channels and forms an adjustable loop that extends from the muzzle body to secure the snout of the animal, which allows the muzzle body to conform and tighten around the snout. Strap ends extend from the rear of the muzzle body, each end having an adjustable buckle. When the buckles are connected together, the strap forms an adjustable rear collar loop around the neck of the animal. The strap is rigid enough to allow the handler to place the muzzle on the animal by merely holding the straps, but flexible enough to slidably engage with the buckles to adjust the effective length of the strap around the animal's neck and snout.

### CROSS-REFERENCE TO RELATED APPLICATIONS

None.

### FIELD OF THE DISCLOSURE

The present invention relates to muzzles, and more specifically, to an adjustable dog muzzle.

### BACKGROUND OF THE INVENTION

Animals often need to be restrained in order to prevent injury both to the animal and to the humans that handle them. Some restraints prevent the entire animal from moving, while other types of restraints, such as muzzles, prevent the animal from biting. Muzzles typically fit around the snout of an animal and prevent the animal from fully opening his or her jaws by using some type of restraint that holds the animal's upper and lower jaws together, thereby reducing chance that the animal can bite the handler.

There are many different types of muzzles. Some muzzles have a cage structure using rigid materials that cannot be adjusted to the size or shape of an animal's snout. One example of a non-adjustable muzzle is disclosed by Weikert in U.S. Pat. No. 1,179,149. Non-adjustable muzzles cannot vary the amount of tension around the jaw and cannot be used effectively on animals of different sizes. Adjustable muzzles attempt to solve some of the drawbacks encountered with non-adjustable muzzles. Adjustable muzzles fit over the snout of animal and the handler to vary the tension to accommodate animals of different sizes. Adjustable muzzles can also be adjusted to permit varying degrees of jaw opening. Adjustable muzzles have been disclosed in U.S. Pat. No. 7,637,231 to Grayson, U.S. Pat. No. 8,596,224 to Taylor, U.S. Pat. No. 4,603,659 to Helphrey, U.S. Pat. No. 4,941,131 to Anderson, U.S. Pat. No. 5,992,352 to Borchelt, and U.S. Pat. No. 5,762,030 to Paglericcio. All patents, patent applications, and non-patent literature cited in this application are hereby incorporated by reference in their entireties, for all purposes.

Still, there remains a continuing need for improved animal muzzles that are simple to adjust and secure around the snout and neck of an animal with minimal risk to the animal or handler animal.

### BRIEF SUMMARY OF THE PRESENT INVENTION

The present invention provides an adjustable device to fit over an animal's snout to prevent biting. The present invention is designed to allow an animal handler to fit a muzzle over an animal's snout without the handler having to directly hold and slide the muzzle body around the animal's jaws, which is required for typical animal muzzles. In order to fit a conventional muzzle around both the lower and upper jaws of an animal, the handler must force the jaws to a substantially closed position or time the placement of the muzzle around the jaws as the animal is closing its mouth. Uncooperative animals typically open their mouths wide as soon as the muzzle begins to approach their face in an effort to attack the handler or muzzle to resist being restrained. Being able to place a muzzle on such an animal without regard to whether their mouth is open or closed would be a significant benefit to the handler. The present invention provides such a solution.

The present invention reduces the likelihood that an animal will bite his or her handler by avoiding the need for the handler to physically close the animal's mouth when slipping the muzzle. The present invention allows the muzzle to be slid over both the upper and lower jaws when the mouth is open, then the muzzle is cinched up to close the jaws. The adjustable tensioning system also allows the device to be used on animals of a variety of sizes.

One element of the device that allows the animal handler to easily place the muzzle body over the animal's snout is a semi-flexible strap. The strap forms both the front loop that wraps around the animal's snout and holds the animal's jaws together. The same semi-flexible strap also forms an adjustable collar around the animal's neck. The strap is rigid enough so that the handler can hold the muzzle by strap ends, which are relatively distant from the muzzle body (and therefore distant from the animal's jaws). The rigidity of the strap connected to the muzzle body suspends and maintains the muzzle body in a substantially horizontal position relative to the strap ends. However, the semi-flexible strap is flexible enough to conform and adjust to the size and shape of the animal's snout and also flexible enough so that the handler can adjust the effective length of the strap around the animal's snout and neck. Adjusting the size of the front loop around the animal's snout, and adjusting the rear collar loop is accomplished easily by the handler. The handler merely pulls the ends of the straps through the strap connector members. The strap slidably engages with the connector members and can be locked in place to set the amount of tension, or loosened by sliding the strap through the connector members in the opposite direction.

In one aspect of the present invention, the invention provides an adjustable muzzle having a muzzle body, a semi-flexible strap, and two connector members secured to the ends of the semi-flexible strap. The muzzle body has a front region, a rear region, and a central region. The muzzle body includes a flexible webbing, a first strap channel, and a second strap channel. The first strap channel and the second strap channel each have a front opening and a rear opening. The strap channels traverse substantially from the front region of the muzzle body to the rear region of the muzzle body. The first connector member is secured to the first end region of the semi-flexible strap and a second connector member secured to the second end region of the semi-flexible strap. The first connector member is capable of coupling the second connector member, thereby bringing the first end region and the second end region of the semi-flexible strap in proximity to each other. When the first and second ends of the semi-flexible strap are in proximity to each other, a rear loop collar region is formed, which encircles the neck of an animal.

In another aspect of the device, the semi-flexible strap is sufficiently rigid to suspend the muzzle body in a substantially horizontal position relative to the semi-flexible strap when the muzzle is held by the first and second end regions of the flexible strap, and the semi-flexible strap is sufficiently flexible to adjustably size the front loop around an animal's snout to conform around the animal's snout and neck.

In another aspect of the device, the first and second connector members are first and second buckles. At least one of the buckles has a cam member capable of adjusting and maintaining an effective length of the semi-flexible strap through at least one of the buckles. The effective length of the semi-flexible strap is accomplished by slidable engagement of the semi-flexible strap through at least one of the first and second buckles.

In another aspect of the device, the cam member only permits unidirectional adjustment of the effective length of the semi-flexible strap when the cam member is not actuated, but permits bidirectional adjustment of the effective length of the semi-flexible strap when the cam member is actuated.

In another aspect of the device the adjustable muzzle has a muzzle body having an anterior opening, a posterior opening, an outer surface, and an inner surface. The muzzle body is characterized as being generally frustum shaped, having a snout receiving passage through the frustum shaped muzzle body. The muzzle body includes a flexible webbing and at least one curved semi-rigid member secured to the flexible webbing between the front opening and the rear opening of the muzzle body. The curved semi-rigid member prevents the front opening and rear opening from collapsing, thereby aiding placement of the muzzle body around the animal's snout by maintaining the two openings at the end of the snout receiving passage. These features aid in placement of the muzzle body around an animal's snout because the curved semi-rigid members help the handler to place muzzle body on the snout without having to directly handle the muzzle body.

The muzzle further includes a first semi-flexible strap and a second semi-flexible strap. The first and second semi-flexible straps are each secured to the flexible webbing at one end of each of the straps. The opposing ends of each of the straps extends away from the second posterior opening of the muzzle body. The first and second semi-flexible straps are sufficiently rigid to enable a handler to place the muzzle body around the animal's snout by only handling the first and second semi-flexible straps, and not requiring that the handler hold the muzzle body directly. The first and second semi-flexible straps each have a connector member attached to it. A first connector member is secured to the first semi-flexible trap and a second connector member is secured to the second semi-flexible strap. The first and second connector are capable of coupling together, and when coupled the first and second semi-flexible straps are in proximity to each other, therein forming a rear loop collar region of the two strap that is positioned around the animal's neck.

In another aspect of the invention, there is a method of adjusting and securing an adjustable muzzle on an animal. The method includes a handler holding a semi-flexible strap, placing the adjustable muzzle described above around the snout of an animal, coupling ends of the semi-flexible strap together, and adjusting the effective length of the semi-flexible strap around the animal's neck and snout.

### BRIEF DESCRIPTION OF THE DRAWINGS

FIG. 1 is a bottom view of an adjustable animal muzzle;

FIG. 2 is a bottom view of the adjustable animal muzzle showing directional arrows indicating direction of pull of the straps to tighten the muzzle;

FIG. 3 is a top view of the adjustable animal muzzle of FIG. 1;

FIG. 4 is a perspective view of the adjustable animal muzzle of FIG. 1;

FIG. 5 is a perspective view of the adjustable animal muzzle of FIG. 1 on a dog;

FIG. 6 is a side view of the adjustable animal muzzle of FIG. 1 on a dog;

FIG. 7 is a rear view of the adjustable animal muzzle of FIG. 1 on a dog;

FIG. 8 is a bottom view of another embodiment of an adjustable animal muzzle;

FIG. 9 is a top view of an embodiment of the adjustable animal muzzle having a frustum shaped muzzle body;

FIG. 10 is a bottom view of the embodiment of FIG. 9;

FIG. 11 is a side view of the embodiment of FIG. 9;

FIG. 12 is a top view of the embodiment of FIG. 9 on a dog;

FIG. 13 is a side view of the embodiment of FIG. 9 on a dog.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein.

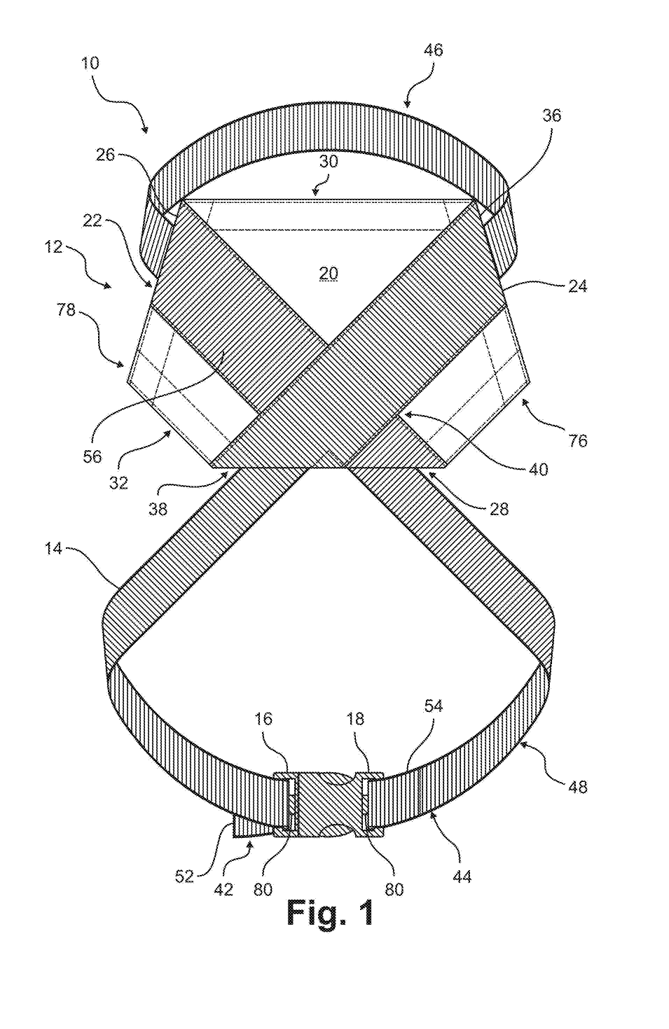

Turning to the Figures, FIG. 1 is one embodiment of the adjustable animal muzzle 10. The muzzle 10 includes: a muzzle body 12, a semi-flexible strap 14, and first and second connector members 16, 18.

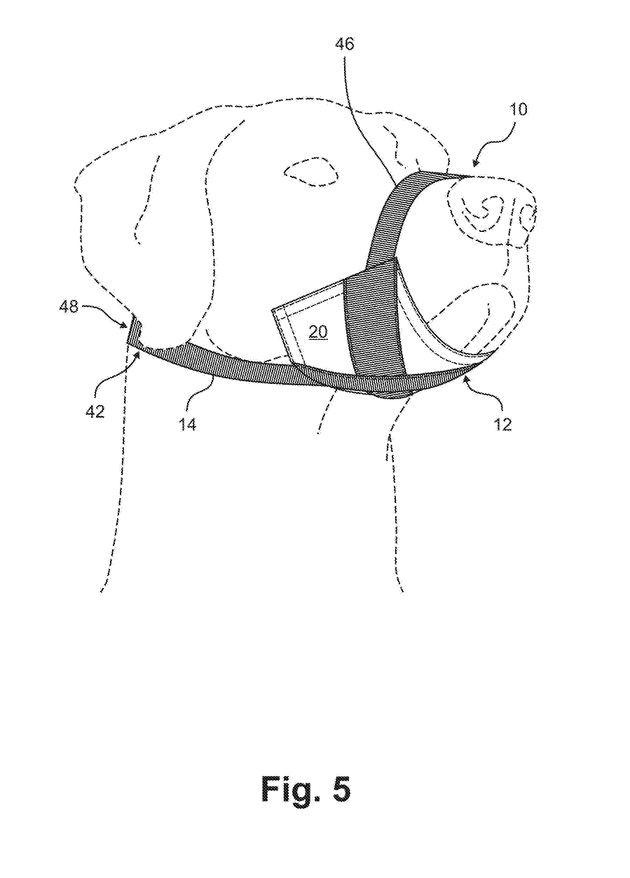

The muzzle body 12 includes flexible webbing 20. As depicted in FIG. 1, the flexible webbing is hexagonal shaped, but may be other shapes that are capable of conforming around an animal's snout, and is particularly useful for placing around a dog's snout. When placed on the animal, the muzzle body 12 should conform to the lower region of the animal's jaw, as depicted in FIG. 5. The muzzle body 12 also includes channels for the semi-flexible strap 14. The channels include a first strap channel 22 and a second strap channel 24. The first strap channel has a front opening 26 and a rear opening 28. The first strap channel 22 traverses substantially from the front region 30 of the muzzle body 12 to the rear region 32 of the muzzle body 12. The second strap 24 channel having a front opening 36 and a rear opening 38. The second strap channel 24 traverses substantially from the front region 30 of the muzzle body 12 to the rear region 32 of the muzzle body 12. Although the flexible webbing 20 can be a variety of shapes and sizes, in one example, the hexagonal shaped webbing 20 has a front edge of approximately 6 inches, a rear edge of approximately 4 inches, front lateral edges approximately 4.5 inches, and rear lateral edges of approximately 2 inches. The lengths of the edges of the flexible fabric can deviate widely from this example, but these lengths provide a flexible webbing 20 that fits and conforms firmly around the lower jaw of medium and large sized dogs. Flexible webbings 20 with shorter edge lengths may be suitable for dogs of smaller size.

The semi-flexible strap 14 has a first end region 42, a second end region 44 and a middle region 46. The middle region 46 forms an adjustably sized front loop 46 extending from the front opening 26 of the first strap channel 22 and loops around to enter the front opening 24 of the second strap channel 36. The first end region 42 extends from the second strap channel 36 and the second end region 44 extends from the first strap channel 26. As depicted in FIG. 1, the first and second strap channels 24, 26 crossover in the central region 40 of the muzzle body 12. A perimeter between the first and second strap channels 24, 26 forms a boundary that defines a first rear lateral region 76 and a second rear lateral region 78 of the flexible webbing 20. These regions 76, 78 of the flexible webbing 20 are loose against the neck of the animal and therefore the rear lateral regions 76, 78 are therefore capable of being folded down to expose portions of the neck and facial regions of the animal while the muzzle body 12 is still tightly secured around the animal's jaw. The rear lateral regions 76, 78 are shaped to allow surgical procedures on the sides of the face of the animal, such as lymph node aspirates, even while the animal is muzzled by allowing a practitioner access to the neck and face region.

Secured to the semi-flexible strap 14 are two connector members 16, 18. A first connector member 16 is secured to the first end 42 of the semi-flexible strap 14 and a second connector member 18 is connected to the second end 44 of the semi-flexible strap 14. The connector members 16, 18 are capable of coupling together, thereby bringing the first end region 42 and second end region 44 of the semi-flexible strap in proximity to each other, therein forming a loop collar region 48 that fits around of the neck of an animal when the connector members 16, 18 are coupled together. The adjustable muzzle 10 is configured to be loosened or tightened so as to adjust to the size of an animal's snout and neck.

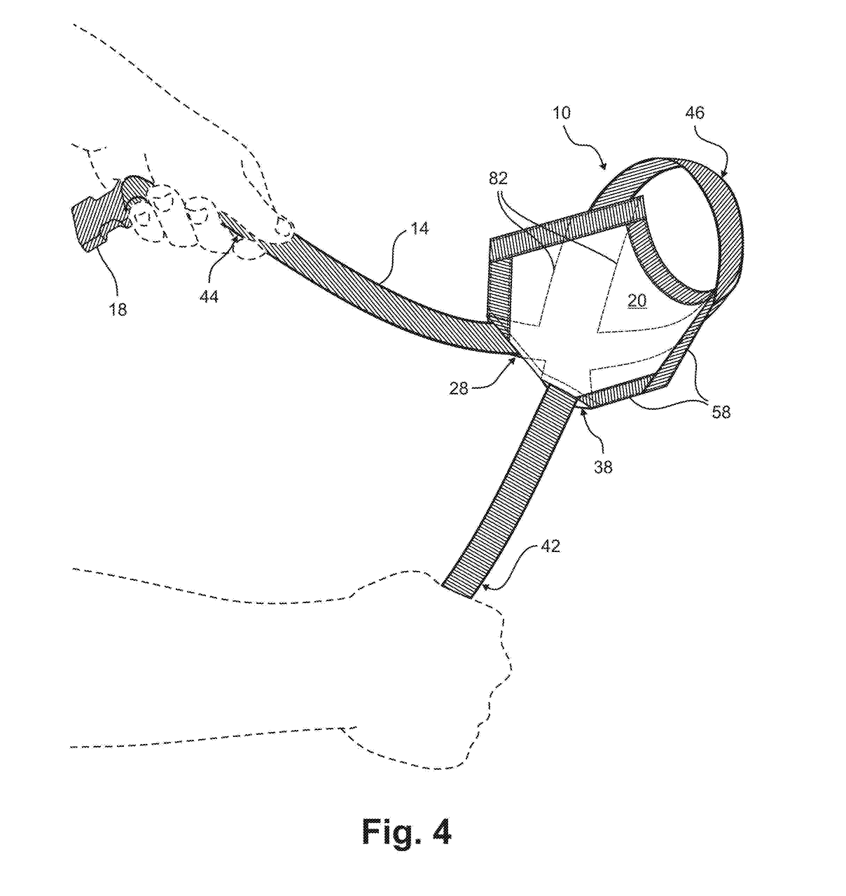

The adjustability and semi-flexibility of the semi-flexible strap 14 are two of the advantages of the present invention. The adjustability allows the handler to adjust the size of the of the front loop region 46 to snugly fit over an animal's snout. As the first and second ends 42, 44 of the semi-flexible strap 14 are tightened by the handler, the effective length of the semi-flexible strap (i.e. the regions of the strap that fit firmly around the snout and neck of the animal) become shorter, thereby tightening the front loop 46 around the animal's snout and tightening the rear loop collar 48 around the animal's neck, as illustrated in FIGS. 4-6. The front loop region 46 and the front region 30 of the muzzle body 12 form an opening where the animal's snout fits through. After the animal's snout is placed through the opening, the semi-flexible strap 12 is pulled by the user and the muzzle body 12 contracts and conforms around the snout of the animal. This contraction reduces the circumference of the opening (formed by the front loop 46 and front region 30 of the muzzle body 12 and increases the curvature of the muzzle body 12 so that the muzzle body 12 fits tightly around the animal's snout when the semi-flexible strap 14 is pulled.

Another advantage of the present invention is the semi-flexible nature of the strap 14. The semi-flexible strap 14 is sufficiently rigid to enable a handler to place the muzzle body 12 around the animal's snout by only handling the first end region 42 and second end region 44 of the strap 14. If the strap 14 were completely flexible, the strap 14 would not have the rigidity and firmness to allow the handler to suspend and maintain the muzzle body 12 in a substantially horizontal orientation relative to the ends of the strap 42, 44 when the handler holds the ends of the strap 42, 44. By suspending and maintaining the muzzle body 12 in a substantially horizontal orientation relative to the strap ends 42, 44, the handler can stand behind the animal, hold the strap ends 42, 44 behind the neck of the animal, and slide the front loop region 46 over the animal's snout, all while the handler maintains a sufficient distance from the animal's mouth to prevent the animal from biting the handler. This method of placing a muzzle around an animal's snout is a safer way than conventional methods that require the handler to hold the muzzle body in his or her hand. In contrast to convention methods of placing a muzzle around an animal's snout, the present invention allows the handler to avoid placing his or her hands near the animal's mouth to secure the muzzle body 12 around the snout.

The semi-flexible strap 14 may be made from a variety of materials known in the art that are used for straps. These materials include leather, flexible plastic, mesh, nylon, natural and synthetic fibers. The semi-flexible strap 14 has the characteristic that it is neither completely rigid to prevent bending, nor so flaccid that gravity causes the muzzle body 12 to droop to the ground when the handler holds the strap's two ends 42, 44. If the semi-flexible strap 14 were completely rigid, the strap 14 could not conform to the shape of the animal's snout and neck, and could not be adjustably sized to the animal's snout and neck. Therefore, the semi-flexible strap 14 should be sufficiently rigid to enable a handler to place the muzzle body 12 around the animal's snout by only handling the first end region 42 and second end region 44 of the semi-flexible strap 14, but the strap 14 should be sufficiently flexible to adjustably size the front loop 46 around the animal's snout by a handler pulling or pushing the first and second end regions 42, 44 of the semi-flexible strap 14. To increase the rigidity of typical straps, a boning (i.e. stiffening) member may be incorporated into the strap 14. In one embodiment, the strap 14 is approximately ¾ inch wide and reinforced with boning within the strap that is approximately a half inch wide and made from heavy duty cable strap (400 lbs tensile strength). Structural characteristics of cable straps and boning are generally known in the art and generally described in U.S. Pat. No. 6,185,791 to Khokar and U.S. patent application Ser. No. 14/746,622 to Fay. Boning to reinforce the strap 14 may also have tensile strengths that are significantly lower or higher to achieve the same effect of flexibility around an animal's neck and snout, while being able to support and maintain the muzzle body in a generally horizontal orientation relative to the first and second ends 42, 44 of the semi-flexible strap 14.

Adjustable muzzles designed for use in small and medium animals could use thinner boning to accomplish the same purpose of being semi-flexible to allows for adjustability and stiffness. In one embodiment of an adjustable muzzle for use in small to medium sized dogs, the boning is approximately 6 mm wide and approximately 1 mm thick. Types of boning that have been found effective for use in the adjustable animal muzzle include the boning materials that are commonly used in corsets. The boning may be applied to the strap in a variety of ways but in a preferred embodiment is sandwiched between between two pieces of flexible strap material. In other embodiments, the semi-flexible strap 14 may be sufficiently rigid and flexible for its intended purpose without adding any additional boning member.

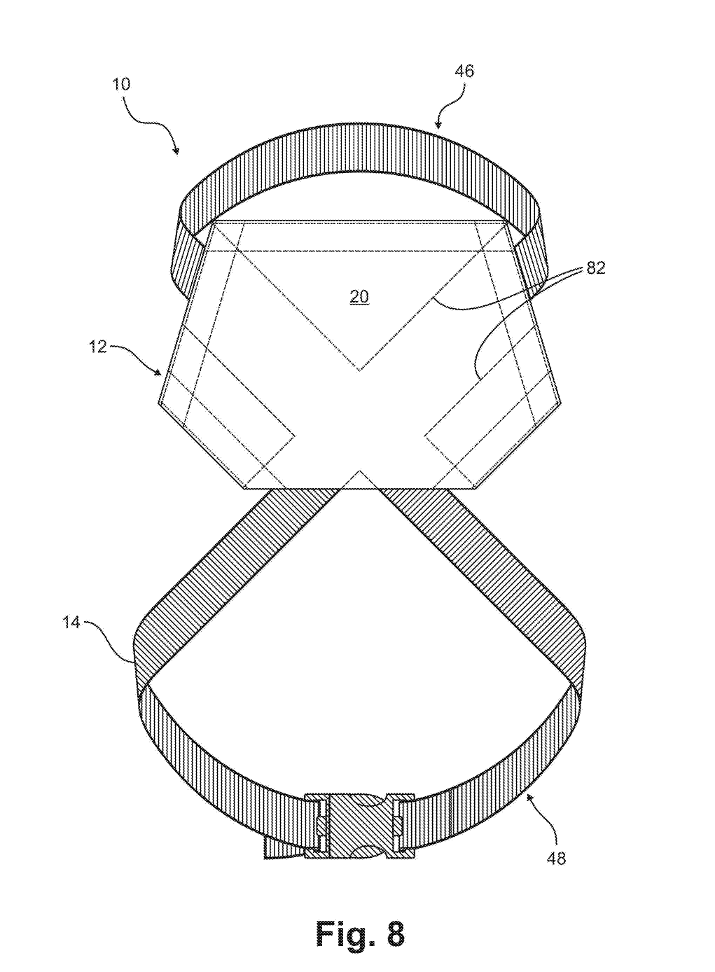

Referring to the flexible webbing 20 of the muzzle body 12, the flexible webbing 20 may be formed from a single layer of material or two layers of material secured together. The flexible webbing may be made from a variety of materials known in the art that are useful for muzzles. These materials include polyester, polypropylene, cotton webbing, nylon webbing, braided elastic, netted elastic, and woven elastic. If the flexible webbing is formed from two layers, the first and second strap channels 22, 24 can each be formed by parallel stitching 82 between the two layers, as shown by the stitching in FIG. 8, where there are two sets of substantially parallel stitching 82 that crossover in an X-shape to allow the strap 14 to be threaded within the channels 22, 24 in a crossover manner. In another embodiment, the channels 22, 24 may be formed by incorporating a reinforcement webbing 56 secured on top of the flexible webbing 20, as illustrated in FIG. 1.

Referring to the first and second connector members 16, 18, the connector members 16, 18 illustrated in the Figures are buckles. The connector members provide a means to connect the ends of the strap together around the animal's neck, and also provide a means to adjust the effect length of the strap to adjust to the size and shape of the animal's neck and snout. Each buckle 16, 18 has a region where the semi-flexible strap 14 is capable of being secured to the buckle 16, 18. At least one the buckles 16, 18 permits the semi-flexible strap 14 to slidably engage with the buckle 16, 18 so that the handler can adjust the effective length of the semi-flexible strap 14 around the animal's neck. In a preferred embodiment, the strap 14 can slidably engage with both buckles 16, 18, but one buckle may be sufficient to provide a means for adjusting the effective length of the strap 14.

In a preferred embodiment, the buckles 16, 18 are cam buckles, but other types of adjustable connector members could be used in the present invention without deviating from the spirit of the invention. In embodiments using a cam buckle 16, 18, the handler threads the strap 14 through the buckle. The buckle 14, 16 allows the strap 14 to be pulled through to tighten the strap 14, thereby tightening the entirety of the muzzle 10 around the animal's neck and snout. The cam 80 prevents the strap 14 from loosening unless the cam member 80 is actuated by the handler (such as by depressing the cam member 80 to disengage the strap 14 from being locked into a specific position within the buckle 16, 18). When the cam member 80 is not actuated, the buckle permits only unidirectional adjustment of strap through the buckle, but when the cam member 80 is actuated, the bidirectional adjustment of the strap can occur. Other types of buckles permitting slidable engagement of the strap may also be used in the present invention without departing from the spirit of the invention. Other types of buckles suitable for use with the invention are side release members, ladderlocks, cord locks and ends, t-glides and d-rings. Non-buckle connector members can also be used as a means to couple the ends of the semi-flexible strap together, such as the use of a plurality of a snaps longitudinally aligned along the semi-flexible strap 14, or hook and loops (Velcro®) positioned longitudinally along the semi-flexible strap 14. These types of non-buckle connector members still allow the handler to connect the two ends of the semi-flexible strap together, directly or indirectly, at a variety of positions along the strap 14.

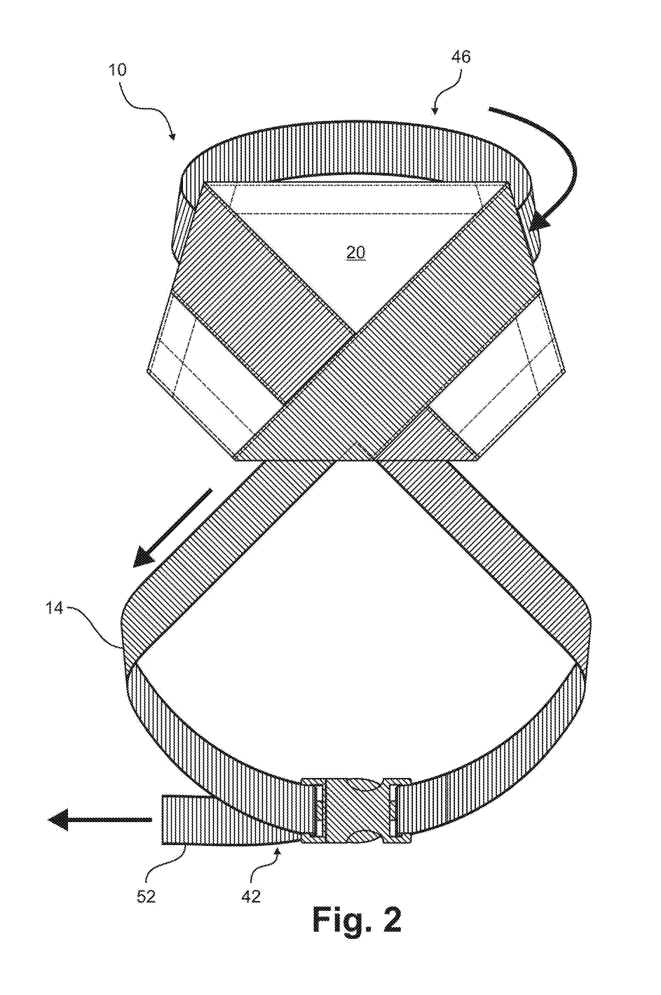

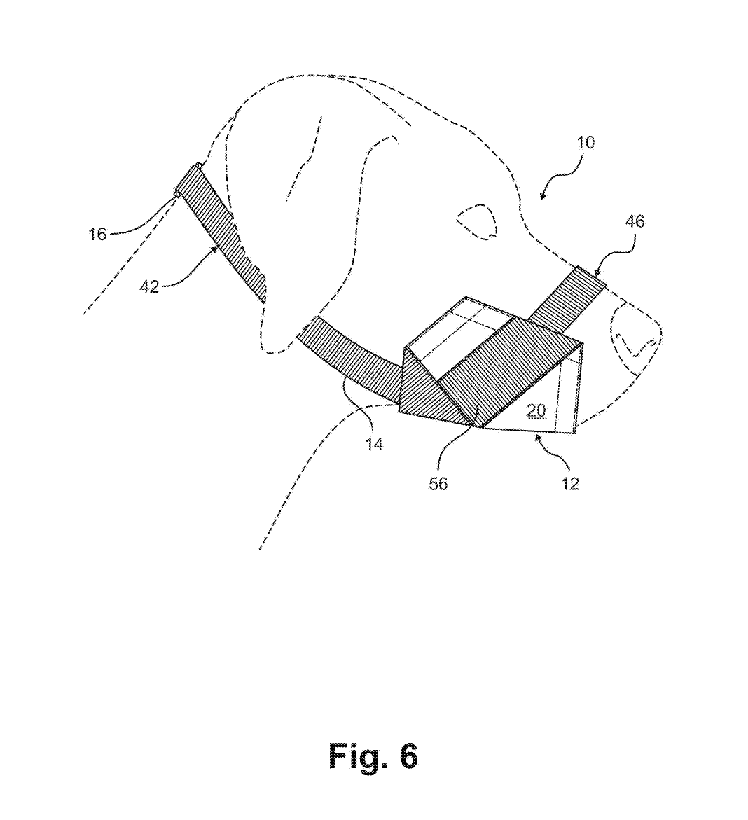

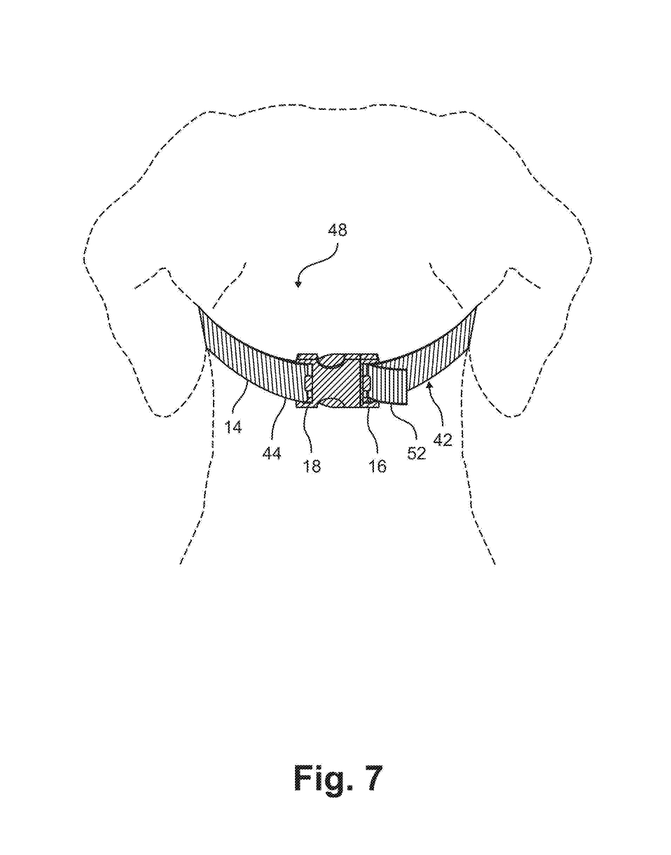

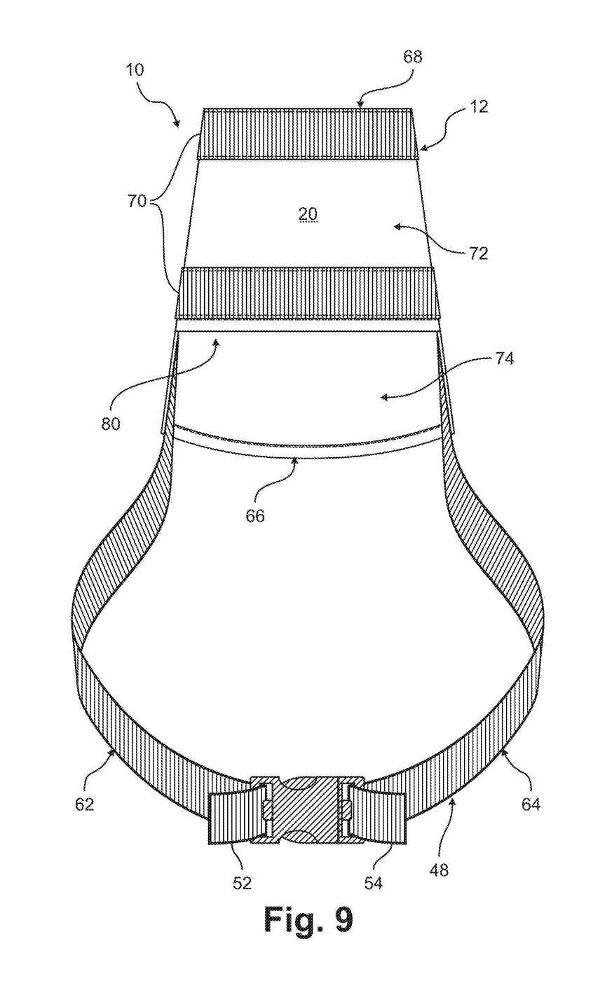

FIG. 2 depicts a bottom view of the adjustable muzzle 10 and the direction in which the strap 14 is pulled to tighten the muzzle 10. The free end 52 of the first end region 42 is pulled in the direction of the arrow as shown. As the handler pulls first end 52 of the semi-flexible strap 14, the size of the front loop 46 is reduced. By pulling the first end 52 through the connector member 16, the front loop 46 contracts the circumference of the muzzle body 20 and so that the muzzle body 20 fits snuggly around the animal's snout and neck, as illustrated in perspective views in FIGS. 4 and 5, side view in FIG. 6, and rear view in FIG. 7. The second end region 44 of the flexible strap 14 may also be a second free end 54 so that both ends of the flexible strap 14 are slidably adjustable (as depicted in straps of FIG. 9), or, as depicted in FIGS. 1 and 2, the second end may be a fixed against the second end region 44 of the flexible strap 14 so that only the first end region 42 is adjustable.

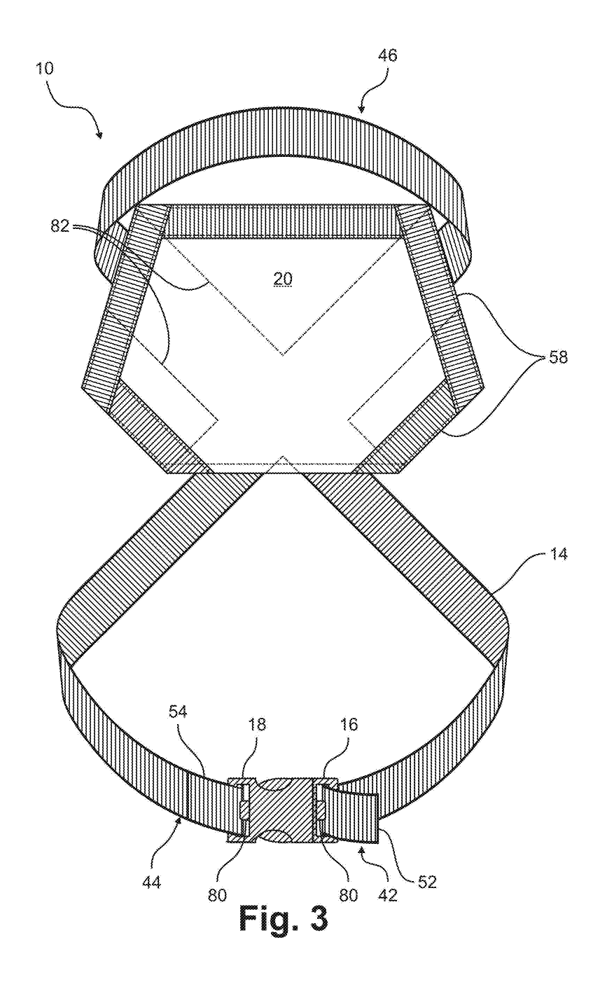

FIGS. 1 and 2 illustrate the bottom view of the adjustable muzzle 10 while FIG. 3 illustrates the top view of the adjustable muzzle 10. This embodiment illustrates the adjustable muzzle 10 having reinforced webbing 56 attached to the flexible webbing 20 to form the strap channel 22, 24 boundaries. The flexible webbing 20 also includes perimeter webbing 58 along the flexible webbing 20 to provide additional support and structural stability to the flexible webbing 20.

FIG. 9 depicts another embodiment of the adjustable muzzle 10. The muzzle body 12 is characterized as being generally frustum shaped and fits over the snout of an animal. In the embodiment shown, the circumference of the muzzle body is not adjustable. Due to the frustum shaped muzzle body 12, the diameter across the frustum decreases from the posterior region of the muzzle body 12 to the anterior region of the muzzle body 12. This narrowing of the diameter of frustum matches the animal's snout, which is narrower in the anterior region compared to the posterior region of the snout.

The muzzle body 12 includes a flexible webbing 20, and attached to the muzzle body 12 are a first semi-flexible strap 62 and a second semi-flexible strap 64 secured to first and second connector members 16, 18, respectively. The muzzle body 12 has a front opening 68 and a rear opening 66. The muzzle body has at least one curved semi-rigid member 70 secured to the flexible webbing 20 between the front opening 68 and the rear opening 66. As illustrated in FIG. 8, two curved semi-rigid members 70, one near the front opening 68 and one near the rear opening 66 prevent the front and rear openings 68, 66 from collapsing, thereby maintaining a substantially open snout passage 78 for the handler to easily slide about the animal's snout. The handler can easily fit the muzzle body 12 over the snout of the animal without placing his or her hands on the muzzle body 12. The handler can slide the muzzle body 12 over the snout of the animal even when the handler is at a distance from the snout of the animal 14 by merely holding flexible straps behind the animal and by pulling the muzzle body 12 over the snout of the animal using the straps 62, 64.

Referring to the semi-flexible straps 62, 64, the strap material and characteristics may be the same as the semi-flexible strap 14 described above. The embodiment shown in FIGS. 9-13 depict first semi-flexible strap 62 attached to the left side and opposing right side of the muzzle body 12. The straps 62, 64 are illustrated as being attached to the inner surface 74 of the muzzle body 12, but the straps 62, 64 can also be attached to the outer surface 72 of the muzzle body 12 without detracting from the spirit of the invention. The curved semi-rigid members 70 preferably are secured to the outer surface 72 of the muzzle body 12, but may be secured to the inner surface 74 or within the flexible webbing 20 of the muzzle body 12.

The connector members 16, 18 have previously been described above with respect to the embodiments shown in FIGS. 1-8. In FIGS. 9-13 the connector members 16, 18 secure the first semi-flexible strap 62 to the second semi-flexible strap 64. When the straps 62, 64 are connected to each other, the resulting structure is a rear loop collar region 48 that is secured around the neck of the animal, and the semi-flexible straps 62, 64 can be effectively lengthened or shortened to securely fit around the neck of the animal. In one embodiment, the connector members 16, 18 are first and second buckles. The buckles may have cam members 80 to adjust and maintain the effective length of the at least one first and second semi-flexible straps 62, 64. Like the embodiments of FIGS. 1-8, the first and second semi-flexible straps 62, 64 are sufficiently rigid to enable a handler to place the muzzle body 12 around the animal's snout by only handling the first and second semi-flexible straps. This allows the handler to place the muzzle body 12 on the animal even when the handler stands behind the head of the animal because the muzzle body 12 can be suspended and maintained in a substantially horizontal orientation relative to the semi-flexible straps 62, 64, even when the straps 62, 64 are held at the strap ends. The semi-flexible straps 62, 64 are also sufficiently flexible to adjustably size the effective length of the first and second semi-flexible straps 62, 64 through the first and second connector members 16, 18. As the straps 62, 64 are tightened, the muzzle body 12 is drawn up the animal's snout, thereby tightening the muzzle about the animal's jaws.

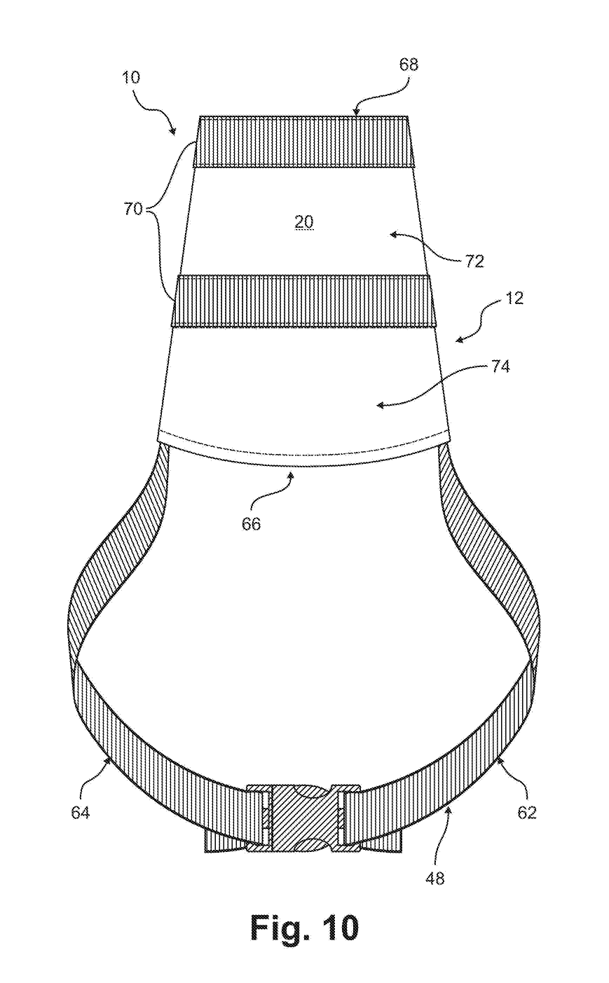

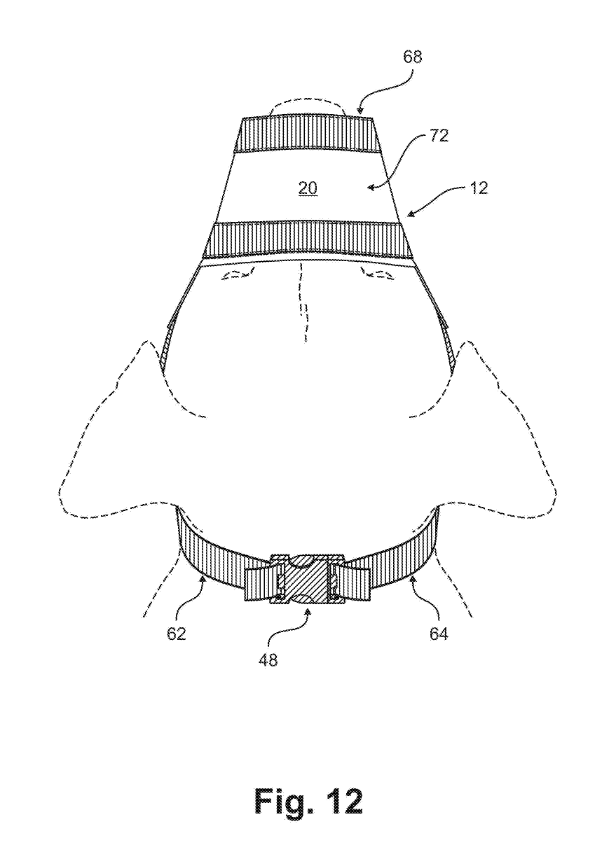

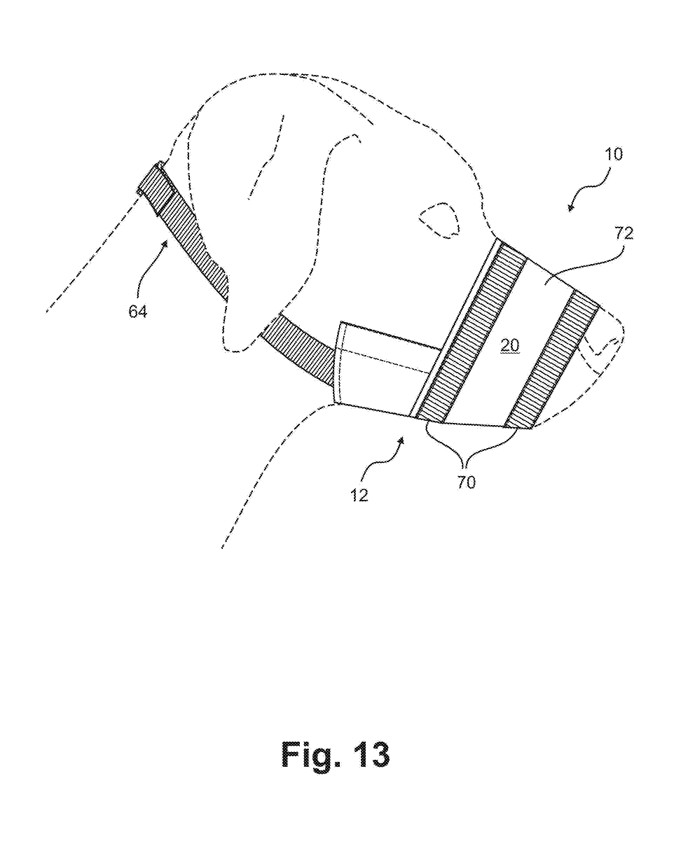

FIG. 9 illustrates a top view of the adjustable muzzle 10 and FIG. 10 illustrates the bottom view of the adjustable muzzle illustrated in FIG. 9. FIG. 10 illustrates a side view of the adjustable muzzle of FIG. 8. FIGS. 12 and 13 illustrate the top and side views, respectively, of the adjustable muzzle 10 placed on a dog.

Advantages of the embodiment shown in FIGS. 9-13 are similar to the advantages in FIGS. 1-8. The semi-flexibility of the straps 62, 64 allow the handler to place the muzzle body 12 over the animal's snout without the handler holding the muzzle body 12 directly, thereby enabling the handler to muzzle the animal without having to place his or her hands near the animal's jaws. Due to the rigidity of the straps 62, 64, the muzzle body 12 is suspended and maintains a relatively horizontal orientation with the straps 62, 64 when the handler holds the muzzle 10 by the straps 62, 64 ends. If the straps were completely flaccid, the muzzle body 12 could not be suspended in a relative horizontal orientation compared to the strap. Rather, the muzzle body 12 would droop down due to gravitational pull on the muzzle body 12 due to the lack of structural support from a more rigid strap. However, the straps 62, 64 are flexible enough to adjustably size the effective length of the semi-flexible straps and conform to the size and shape of the animal's anatomy.

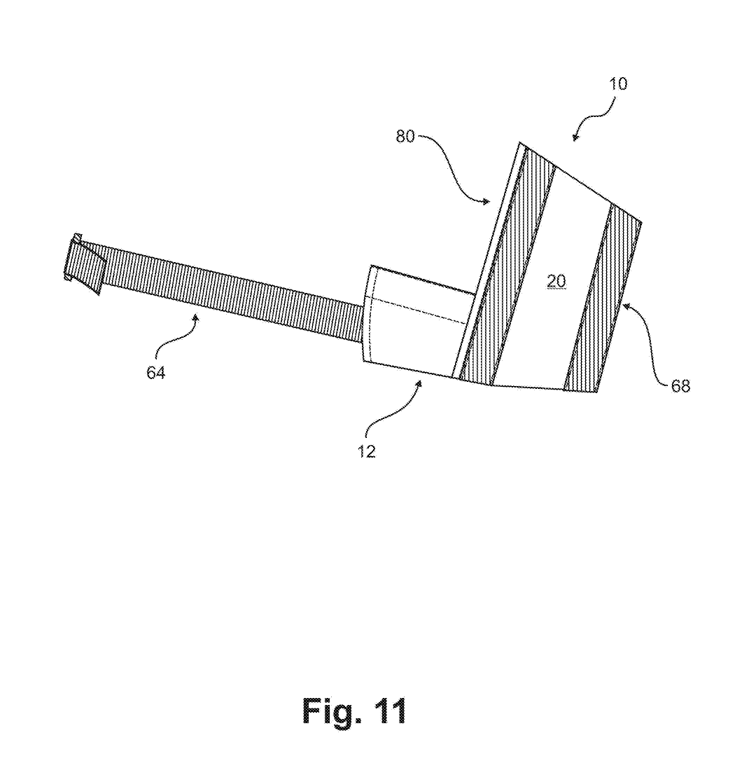

FIG. 11 depicts a side view of the adjustable muzzle where the muzzle body 12 is suspended substantially in the same horizontal plane as the straps 62, 64. This allows the handler to stand behind the animal, away from the animal's jaws and place the muzzle body 12 over the animal's snout while the handler remains behind the animal, and while the handler only holds the straps 62, 64. From behind the animal, the handler can then slide the muzzle body 12 over the animal's snout from an anterior to posterior direction by pulling the straps 62, 64 toward the posterior region of the animal's body. Once the muzzle body 12 is over the animal's snout, the handler couples the connector members 16, 18 and adjusts the effective length of the first and second semi-flexible straps 62, 64 to tightly secure the straps 62, 64 together around the animal's neck. The connector members 16, 18 may have the same features as the connector members already described above in the embodiments of FIGS. 1-8. As the effective lengths of the semi-flexible straps 62, 64 are shortened by pulling on the straps 62, 64, the muzzle body 12 slides in a posterior direction so that the muzzle body 12 slides to the rear of the jaw, which further prevents the animal from easily opening its jaws and biting the handler.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. An adjustable muzzle comprising:
i) a muzzle body having a front region, a rear region, and a central region, the muzzle body having,
a) a flexible webbing,
b) a first strap channel having a front opening and a rear opening, the first strap channel traversing substantially from the front region of the muzzle body to the rear region of the muzzle body,
c) a second strap channel having a front opening and a rear opening, the second strap channel traversing substantially from the front region of the muzzle body to the rear region of the muzzle body;
ii) a semi-flexible strap capable of insertion within both the first and second strap channels, the semi-flexible strap having: a first end region, a second end region, and a middle region, the middle region adapted to form an adjustably sized front loop extending from the front opening of the first strap channel and the front opening of the second strap channel, the first end region extending from the rear opening of the first strap channel, the second end region extending from the rear opening of the second strap channel; and
iii) a first connector member secured to the first end region of the semi-flexible strap and a second connector member secured to the second end region of the semi-flexible strap, wherein the first connector member is capable of coupling the second connector member thereby bringing the first end region and second region end region of the semi-flexible strap in proximity to each other, therein forming a rear loop collar region of the semi-flexible strap when the first and second connector members are coupled together;
whereby the adjustable animal muzzle is configured to be loosened or tightened so as to adjust to the size of an animal's snout and neck.

2. The device of claim 1, wherein the semi-flexible strap is sufficiently rigid to suspend the muzzle body in a substantially horizontal position relative to the semi-flexible strap when muzzle is held the first and second end regions of the flexible strap, and wherein the semi-flexible strap is sufficiently flexible to adjustably size the front loop around an animal's snout to conform around the animal's snout and neck.

3. The device of claim 1, wherein the flexible webbing is formed from first and second flexible webbing layers, and wherein the first and second strap channels are formed between the first and second flexible webbing layers.

4. The device of claim 1, wherein the muzzle body further comprises at least one reinforcement webbing secured to the flexible webbing, and wherein the first and second strap channels are formed between the flexible webbing and the reinforcement webbing.

5. The device of claim 1, wherein the semi-flexible strap comprises boning, thereby increasing stiffness of the semi-flexible strap.

6. The device of claim 1, wherein the first strap channel and the second strap channel crossover at the central region of the muzzle body.

7. The device of claim 1, wherein the first and second connector members are first and second buckles, respectively.

8. The device of claim 7, wherein at least one of the first and second buckles has a cam member capable of adjusting and maintaining an effective length of the semi-flexible strap through the at least one of the first and second buckles.

9. The device of claim 8, wherein the cam member only permits unidirectional adjustment of the effective length of the semi-flexible strap when the cam member is not actuated, but permits bidirectional adjustment of the effective length of the semi-flexible strap when the cam member is actuated.

10. The device of claim 1, wherein the semi-flexible strap is made from a material selected from the group consisting of polyester, polypropylene, cotton webbing, nylon wedding, braided elastic, netted elastic, and woven elastic.

11. The device of claim 1, wherein the flexible webbing is made form a material selected from the group consisting of leather, flexible plastic, mesh, and nylon.

12. The device of claim 1, wherein the flexible webbing has a first rear lateral region and a second rear lateral region, wherein the first and second rear lateral regions are capable of folding down when the adjustable animal muzzle is tightly secured around the animal, thereby permitting a practitioner access to the face and neck of an animal for surgical procedures even while the animal is muzzled.

13. An adjustable muzzle comprising:
i) a muzzle body having a front opening, a rear opening, an outer surface, an inner surface, and characterized as being generally frustum shaped and having a snout receiving passage, the muzzle body having:
a) a flexible webbing
b) at least one curved semi-rigid member secured to the flexible webbing between the front opening and the rear opening, whereby the at least curved semi-rigid member prevents the front opening and the rear opening from collapsing, thereby aiding placement of the muzzle body around an animal's snout by not requiring a handler to handle the muzzle body directly when placing the muzzle body on the animal's snout.
ii) a first semi-flexible strap and a second semi-flexible strap, the first and second semi-flexible straps each secured to flexible webbing at one end of each strap, and each of the first and second semi-flexible straps extend away from the second opening of the muzzle body, wherein the first and second semi-flexible straps are sufficiently rigid to enable a handler to place the muzzle body around an animal's snout by only handling first and second semi-flexible straps; and,
iii) a first connector member secured to the first semi-flexible strap, and a second connector member secured to the second semi-flexible strap, wherein the first connector member is capable of coupling the second connector member thereby bringing the first and second flexible straps in proximity to each other, therein forming a rear loop collar region when the first and second connector members are coupled together.

14. The device of claim 13, wherein the first and second connector members are a first and a second buckle, respectively, wherein at least one of the first and second buckles has a cam member to adjust and maintain effective length of the at least one first and second semi-flexible straps.

15. The device of claim 13 wherein the first and second semi-flexible straps are sufficiently rigid to enable a handler to place the muzzle body around an animal's snout by only handling the first and second semi-flexible straps, thereby allowing the handler to place the muzzle on the animal when the handler stands afar from the animal's snout, and wherein the semi-flexible strap is sufficiently flexible to adjustably size an effective length of the first and second semi-flexible straps and substantially conform to the shape of an animal's neck.
